(19) United States
(12) Patent Application Publication
(10) Pub. No.: US 2010/0301554 A1
(43) Pub. Date: Dec. 2, 2010

(54) GAME CARD FOR CHANCE AT ADDITIONAL CARD

(76) Inventor: Mary DiBenedeto, New York, NY (US)

Correspondence Address: Mary DiBenedeto, 105 Duane Street, Apt. 5E, New York, NY, 10007, US

(21) Appl. No.: 12/608,982

(22) Filed: Oct. 29, 2009

Related U.S. Application Data
(60) Provisional application No. 61/217,057, filed on May 26, 2009.

(51) Int. Cl. A63B 71/00; B42D 15/00

(52) U.S. Cl. 273/139; 283/102

(57) ABSTRACT

A scratch-off game card comprising a scratch-off game thereon and further comprising a part of the game card revealing symbol or symbols are indicating that the bearer of the card or the title holder of the card is entitled to a certain quantity of free scratch-off game cards.

### CROSS-REFERENCE TO RELATED APPLICATIONS

This non-provisional application claims priority from U.S. provisional application 61/217,057, filed May 26, 2009. This non-provisional application is not a conversion of said provisional application.

### FEDERALLY SPONSORED RESEARCH

Not Applicable

### SEQUENCE LISTING OR PROGRAM

Not Applicable

### FIELD OF INVENTION

This invention relates to scratch-off games.

### BACKGROUND OF THE INVENTION

Scratch-off lottery cards, wherein the card contains lying beneath the scratch-off coating various symbols which indicate whether the card is a winning or losing card, is used in many state lottery games. The “scratch-off” is used to prevent the player from being able to view the symbol or symbols which would indicate whether the card was a winning or losing card. However, when the coating is removed, whether the card is a winning or losing card is revealed.

The standard scratch-off game card, involves a predetermined winner or loser card, which when the scratch-off coating is removed and all the symbols are revealed, the player will know whether the card is a winning or losing card. New games are constantly being developed and introduced in order to appeal to purchasers of said scratch-off game cards.

Scratch-off game cards come in a variety of games. For example, U.S. Pat. No. 5,118,109 claims a scratch-off game card that alleges an instant poker game with removable scratch-off coated portions, which when the scratch-off portion is removed, the underlying symbols indicate the cards of a poker hand. The card further includes other scratch-off portions which indicate possible combinations which can be kept from the initial starting hand which allows a player to draw any number of additional cards in an effort to improve the rankings of the final hand. All symbols underneath the scratch-off coatings aids in the playing of the poker game.

U.S. Patent Application Publication No. 20090121425 claims a scratch-of game offering a player with a card, not a winning card in the initial scratch-off game, a second “bonus” game on the same lottery card, in which the player will be a guaranteed winner. U.S. Patent Application Publication No. 2006/0178194 claims the combination of a lottery card paying off in a raffle-style game after certain wins in the lottery section but not after loss in the lottery section.

There are word-based scratch-off game cards wherein a player buys a card with a word or set of words and may win a prize if the outcome of a draw confers a win status to one or more words in the card. U.S. Pat. No. 7,497,778.

Sporting event based lottery games wherein the lottery game result depends on the performance of competitors in the sporting event and the prize determination process does not involve any comparison among the game tickets, are also available. U.S. Pat. No. 7,485,037.

Further, there are Bingo-styled scratch-off lottery game card which simulates the rules of Bingo are available. U.S. Pat. Nos. 5,560,610, 7,481,431.

There are many players of scratch-off card games who play for their enjoyment and an opportunity to win some prize. For each play the player is required to purchase a new scratch-off game card; this is also true of the losers of the scratch-off card.

Although scratch-off card games having a scratch-off coating covering symbols required to play a particular game, with specific rules for the scratch-off game being played, there has been no scratch-off card games heretofore invented in which a separate scratch-off portion is added to the scratch-off game card, wherein the underlying symbol or symbols of the separate scratch-off portion indicates whether the holder or person with title to the scratch-off game card is entitled to receive a certain sum of extra game cards, regardless of the outcome of any other scratch-off game being played or comprised in the scratch-off game card.

Thus, there remains a need for a scratch-off game card with a separate scratch-off portion which indicates whether the holder or person with title to the scratch-off game card is entitled to receive a certain sum of extra game cards without purchase of more cards, regardless of the outcome of any other scratch-off game being played on the scratch-off game or comprised in the scratch-off game card, as an extra incentive to reward losers of a scratch-off card game with an opportunity on the same game card a chance to win certain sum of extra cards.

### SUMMARY OF INVENTION

In accordance with the present invention, a game card having a scratch-off coating section thereon covering a scratch-off game and another section thereon covering a symbol or symbols, wherein the symbol or symbols underlying the other section of the scratch-off coating indicates whether the bearer of the card or the title holder of the game card is entitled to certain amount of free additional game cards without purchase of more cards.

### BRIEF DESCRIPTION OF DRAWINGS

### Figures

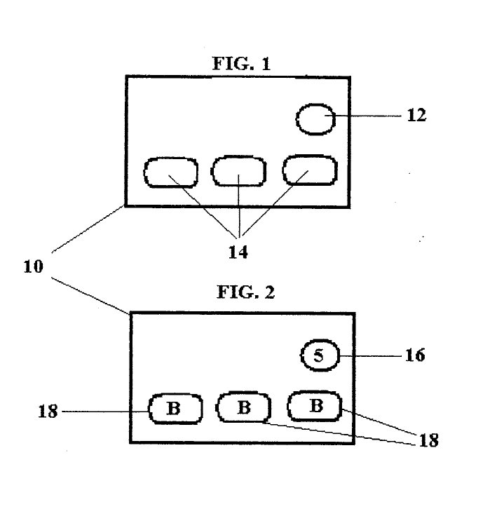

FIG. 1 shows a scratch-off game card comprising a scratch-off section of the scratch-off game card with a scratch-off coating under which there is a scratch-off game and a symbol which indicates whether the bearer of the card or the title holder of the game card is entitled to certain of free additional game cards.

FIG. 2 shows a scratch-off game card comprising a scratch-off section of the scratch-off game card with the scratch-off coating removed from the card revealing a scratch-off game and a symbol indicates whether the bearer of the card or the title holder of the game card is entitled to certain of free additional game cards.

### DRAWINGS

### Reference Numerals

10 Scratch-off game card; 12 Scratch-off coated section for indicating whether the bearer of the card or the title holder of the game card is entitled to certain sum of free additional game cards or not; 14 Scratch-off coated section of the scratch-off game card representing a scratch of game. 16 A symbol underlying scratch-off coating which indicates whether the bearer of the card or the title holder of the game card is entitled to certain of free additional game cards or not; 18 Symbols which representing a scratch of game.

### DETAILED DESCRIPTION

The present invention will now be described more fully with reference to the accompanying drawings in which the preferred embodiment of the invention is shown. This invention may however be embodied in many different forms and should not be construed as limited to the embodiment set forth herein. Rather, the embodiment is provided so that this disclosure will be thorough and fully convey the scope of the invention to those skilled in the art. Like numbers in the drawings refer to like elements throughout.

In a first aspect of this invention and in accordance with FIG. 1, this invention provides a scratch-off game card 10. The scratch-off game card 10 comprising thereon a first scratch of section of the scratch-off game card with a scratch-off coating that under said scratch-off coating lies at least one symbol which indicates whether the bearer of the card or the title holder of the game card is entitled to certain amount of free additional game cards 12. The invention also provides another scratch-off coated section, or sections 14, which cover a scratch-off game.

In a second aspect of this invention and in accordance with FIG. 2 this invention, FIG. 2 provides a scratch-off game card 10 without any scratch-off coating thereon. In this aspect the scratch-off game card 10 comprises thereon a symbol 16 which indicates whether the bearer of the card or the title holder of the game card is entitled to certain amount of free additional game cards. In this aspect the invention also provides another symbol, or symbols 18, which are used to play a scratch-off game.

In a third aspect of this invention, the invention provides a scratch-off game card 10 without a scratch-off coating thereon covering a symbol 16 which indicates whether the bearer of the card or the title holder of the game card is entitled to certain amount of free additional game cards and a scratch-off coated section covering another symbol 14, or symbols, which is used to play a scratch-off game.

In a forth aspect of this invention, the invention provides a scratch-off game card 10 with a scratch-off coating thereon covering a symbol 12 which indicates whether the bearer of the card or the title holder of the game card is entitled to certain amount of free additional game cards and a symbol 18, or symbols, which is used to play a scratch-off game.

“Scratch-off game card” (depending on context may also be known as: scratchcard; scratch off; scratch ticket; scratcher; scratchie; scratch-it; scratch game; scratch-and-win or instant game) is a small token, usually made of cardboard, where one or more areas contain concealed information covered by a substance that cannot be seen through, but can be scratched off.

“Scratch-off game” is, but not limited, a game that may require the player of the to match three (or varying numbers) of the same prize amounts to win an amount of money; may involve matching symbols, pictures or words, or games like Blackjack, Poker, Monopoly, or it may be tied to popular themes such as Harley Davidson, Major League Baseball, NASCAR, the National Hockey League, Marvel Comics and FIFA World Cup.

“Symbol” includes but is not limited to symbols, a word, words, a number, numbers, a mark or marks.

While this invention has been described as having a preferred embodiment it is understood that it is capable of further modifications, uses and/or adaptations of the invention following in general the principle of the invention and including such departures from the present disclosure as come within known or customary practice in the art to which the invention pertains, and as may be applied to the central features hereinbefore set forth, and fall within the scope of the invention and the limits of the appended claims.

What is claim is:

1. A game card, comprising:
a) a least one scratch-off game which does not indicate whether the bearer of the game card or the title holder of the card is entitled to a certain amount of more game cards; and
b) a symbol on the game card representing whether the bearer of the game card or the title holder of the game card is entitled to certain amount of more game cards.

2. The game card of claim 1, further comprising a scratch-off coating covering the symbol.
